(19) United States
(12) Patent Application Publication
(10) Pub. No.: US 2016/0124250 A1
(43) Pub. Date: May 5, 2016

(54) PIXELATED TUNABLE COLOR FILTER

(71) Applicant: PRESIDENT AND FELLOWS OF HARVARD COLLEGE, Cambridge, MA (US)

(72) Inventors: Ethan Schonbrun, Newton, MA (US); Giuseppe Di Caprio, Cambridge, MA (US); Gudfridur Möller, Reykjavik (IS); Richard Christopher Stokes, Cambridge, MA (US)

(73) Assignee: President and Fellows of Harvard College, Cambridge, MA (US)

(21) Appl. No.: 14/889,501

(22) PCT Filed: May 23, 2014
(86) PCT No.: PCT/US2014/039272

§ 371 Date: Nov. 6, 2015

Related U.S. Application Data
(60) Provisional application No. 61/826,604, filed on May 23, 2013.

(51) Int. Cl. G02F 1/01; H04N 9/097; H04N 5/225; G02B 5/30; G02F 1/13

(52) U.S. Cl. CPC G02F 1/0136; G02B 5/3083; G02F 1/1313; H04N 5/2254; H04N 9/097

(57) ABSTRACT

Methods and apparatus using generating multiple color images in a single exposure. In one implementation, an imaging apparatus is provided that includes an image sensor array including a plurality of image sensor elements. The imaging apparatus also includes a dispersive element configured to rotate incident linearly polarized radiation by a rotation angle to produce rotated linearly polarized radiation having at least two polarization angles, wherein the rotation angle is determined based, at least in part, on a wavelength of the incident linearly polarized radiation. The imaging apparatus also includes a pixelated polarizing filter configured to receive the rotated linearly polarized radiation from the dispersive element and selectively pass the rotated linearly polarized radiation to the image sensor array, wherein the rotated linearly polarized radiation is selectively passed based on the polarization angle of the rotated linearly polarized radiation.

### RELATED APPLICATIONS

This Application claims priority to U.S. Provisional Application No. 61/826,604, filed May 23, 2013, which is incorporated by reference herein in its entirety.

### BACKGROUND

Multispectral imaging, which obtains optical representations in two or more ranges of frequencies or wavelengths, has proven to be an extremely valuable technology for capturing spatial and spectral information of an object. An example of a multispectral imaging system is a color camera. Most conventional color cameras include a color filter array (CFA) to simultaneously collect multiple images of a scene corresponding to the different color filters in the array. A Bayer color filter array, which includes red, green, and blue filters formed as a thin film or adsorbing dye-based substrate placed over the image sensor of a camera, is an example of typical CFA used in commercially-available color cameras. Each of the filters in the CFA is arranged in a path between incident light and an element (e.g., pixel, sub-pixel, group of pixels) of an image sensor in the camera to filter the incident light based on its wavelength. Three color images of a scene based on information recorded by the image sensor elements associated with the red, green, and blue filters in the CFA are captured in a single exposure, and are combined to produce a final color image.

Using the above-described conventional CFA techniques, information from multiple spectral ranges is determined in a single exposure, but at the expense of spatial resolution due to the fact that only a subset of the image sensor elements record information for each of the colors of the CFA. To achieve images with high spatial resolution, some commercial multispectral systems rely on either spatial or wavelength scanning in order to collect all three dimensions of the data cube. Scanning typically takes a few seconds. The scanned data is then combined to produce a final color image with high spatial and spectral resolution.

### SUMMARY

According to one aspect of the technology described herein, an imaging apparatus is described. The imaging apparatus includes an image sensor array including a plurality of image sensor elements, a dispersive element configured to rotate incident linearly polarized radiation by a rotation angle to produce rotated linearly polarized radiation having at least two polarization angles, wherein the rotation angle is determined based, at least in part, on a wavelength of the incident linearly polarized radiation, and a pixelated polarizing filter configured to receive the rotated linearly polarized radiation from the dispersive element and selectively pass the rotated linearly polarized radiation to the image sensor array, wherein the rotated linearly polarized radiation is selectively passed based on the polarization angle of the rotated linearly polarized radiation.

According to another aspect, a method of generating a plurality of color-filtered images in a single exposure is described. The method comprises rotating incident linearly polarized light by a rotation angle based, at least in part, on a wavelength of the incident linearly polarized light to produce rotated linearly polarized light, filtering, by a pixelated polarization filter, the rotated linearly polarized light based on its rotation angle, wherein the pixelated polarization filter includes at least one first filter element that selectively passes rotated linearly polarized light having a first angle and at least second filter element that selectively passes rotated linearly polarized light having a second angle, and generating a first image and a second image of the plurality of images based on light passing through the at least one first filter element, and the at least one second element, respectively.

According to another aspect, a tunable multispectral imaging system for simultaneously measuring radiation at multiple wavelengths is described. The multispectral imaging system comprises a tunable optical dispersive element configured to encode color information by rotating incident light at particular rotation angles based on a wavelength of the incident light; a polarization filter including a plurality of filter elements, wherein at least two of the filter elements are configured to selectively pass the rotated incident light having different polarization angles; and an image sensor array configured to sense the light passed by the polarization filter and to generate multiple color images based on the sensed light.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

Various non-limiting embodiments of the technology will be described with reference to the following figures. It should be appreciated that the figures are not necessarily drawn to scale.

FIG. 1 illustrates a schematic of an imaging system for generating color images based on spectrally dependent polarization rotation, in accordance with some embodiments;

FIG. 2 illustrates a schematic of a portion of the imaging system of FIG. 1;

FIGS. 3A and 3B illustrate schematic representations for encoding color using polarization in accordance with some embodiments;

FIGS. 4A and 4B illustrate tunable transmission spectra through an optical dispersive element having lengths of 10 cm and 30 cm, respectively, in accordance with some embodiments;

FIGS. 5A and 5B illustrate tunable transmission spectra through an optical dispersive element having lengths of six inches and twelve inches, respectively, in accordance with some embodiments;

FIG. 5C illustrates a multispectral image of hemoglobin in a red blood cell recorded in accordance with some embodiments;

FIG. 6. illustrates a schematic of an imaging system including a liquid crystal dispersive element, in accordance with some embodiments;

FIG. 7A illustrates the base 10 decay length due to absorption of oxygenated and deoxygenated hemoglobin having a molar concentration of 2.3 mM;

FIG. 7B illustrates results of an experiment in which hemoglobin was measured in red blood cells traveling through a microfluidic channel illuminated using LEDs with wavelengths of 420, 455, and 617 nm using an imaging apparatus constructed in accordance with some embodiments;

FIG. 7C illustrates transmitted light images through a thumb recorded in accordance with some embodiments using LEDs with wavelengths 660 and 850 nm and a photoplethysmograph retrieved from the video signal;

FIG. 8 is a photograph of an imaging system constructed in accordance with some embodiments; and

FIG. 9 shows photographs of a U.S. five dollar bill imaged with an imaging system constructed in accordance with some embodiments.

### DETAILED DESCRIPTION

The inventors have recognized and appreciated that conventional multispectral imaging systems may be improved by using a pixelated tunable color filter (PTCF) that generates color images based on polarization of radiation rather than filtering radiation using thin film or absorbing dye-based color filter arrays. As described above, many conventional color cameras use a color filter array (CFA) to simultaneously collect multiple images of a scene corresponding to red, green, and blue. Although this set of filters matches well to the sensitivity of human vision, it is often insufficient for spectroscopic imaging applications. Other multispectral systems have been developed which capture multiple images with high-spatial and spectral resolution using scanning techniques. However, such systems are limited in their ability to capture dynamic events often observed in biomedical imaging applications.

Some embodiments relate to an alternative CFA technology that combines an optically dispersive element with a pixilated polarizing filter to separate color information based on polarization rotation. The dispersive element optically interacts with incident radiation to map color information in the incident radiation to polarization characteristics. The polarizing filter filters the radiation exiting the dispersive element based on its polarization angle. When integrated with an image sensor, a resulting camera is configured to capture multispectral images in a single exposure and is ideal for applications including, but not limited to, biomedical imaging of cells in fluid flow and kinetic physiological events, like tissue oximetry.

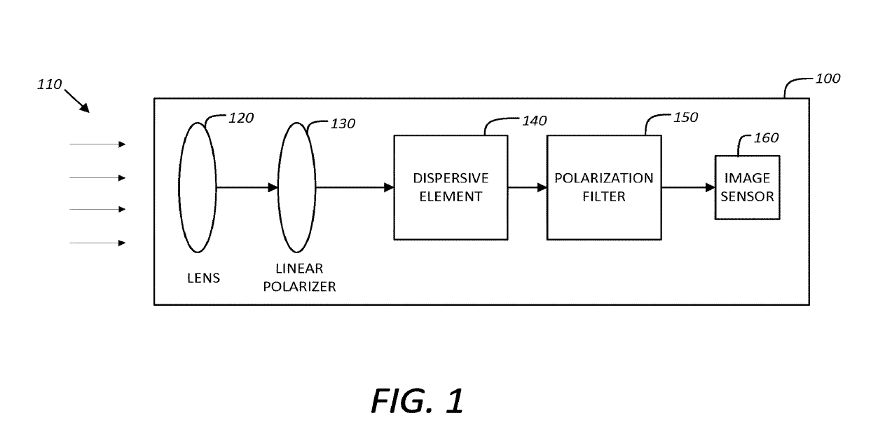

FIG. 1 shows a schematic of a color camera 100 that outputs color images in accordance with some embodiments. Camera 100 includes lens 120 that receives and focuses incident radiation (e.g., light) 110. Any suitable lens may be used, and embodiments are not limited in this respect. The focused radiation is transmitted to linear polarizer 130, which converts the incident radiation having undefined or mixed polarization into a beam of linear polarized radiation. Any suitable linear polarizer may be used, and embodiments are not limited in this respect. The linearly-polarized radiation is then transmitted to optical dispersive element 140, which maps color of the incident radiation to polarization characteristics, as described in more detail below. Non-limiting examples of dispersive elements that may be used in some embodiments are discussed in more detail below. The output of dispersive element 140 is transmitted to polarization filter 150, which includes elements that selectively pass radiation based on its polarization. Non-limiting examples of polarization filters that may be used in some embodiments are discussed in more detail below. The elements of polarization filter 150 are formed over corresponding elements of image sensor 160, which includes image sensor elements (e.g., photodiodes) that sense the filtered radiation. Any suitable image sensor may be used including, but not limited to CMOS image sensors and CCD-based image sensors.

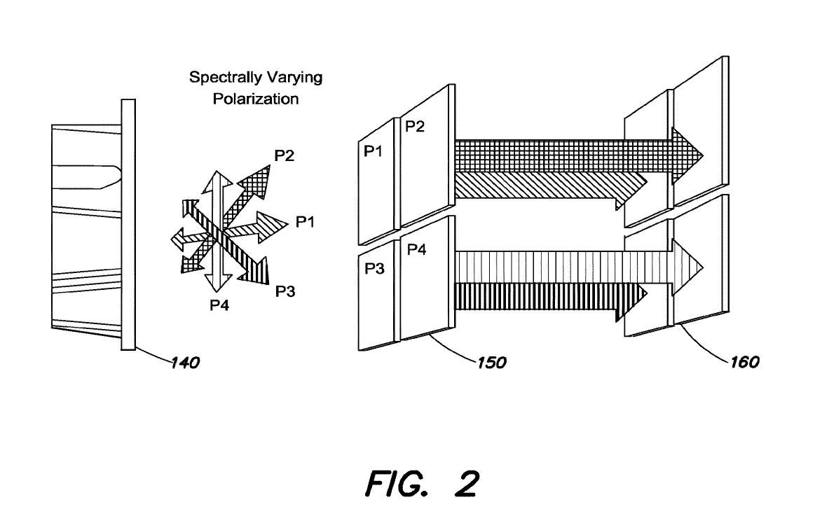

Optical dispersive element 140 may be implemented in any suitable way, and embodiments are not limited in this respect. The optical dispersive element encodes color of incident light by rotating light having certain wavelengths by a particular polarization angle, which can subsequently be filtered and sensed, as discussed in more detail below. In some embodiments, optical dispersive element 140 comprises a cylinder filled with an optically active material. Optically active materials rotate linearly polarized light by a rotation angle that is inversely proportional to the wavelength of the incident light. Different colors exit the optically dispersive element having different polarization angles and can consequently be filtered by an output polarizer, such as polarization filter 150. The rotation angle of the polarizer controls the transmitted color, as shown in FIG. 2. In the imaging system of FIG. 2, incident light processed by the dispersive element is characterized using four polarization angles, each coding a different color, which is then sensed by a polarization filter. Any suitable optically-active material may be used to encode color and polarization. Such optically-active materials include, but are not limited to, chiral liquids, such as Limonene, or any other substance that rotates light having different wavelengths/colors to different polarization angles.

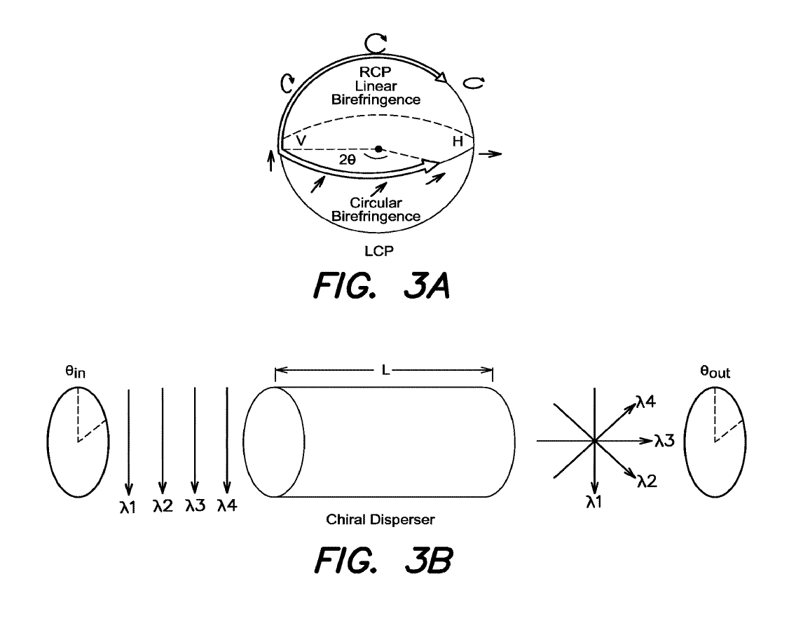

The polarization of light propagating through an anisotropic medium can be visualized as a trajectory on the surface of a Poincare sphere, as shown in FIG. 3A, which illustrates the trajectory of vertically polarized, polychromatic light as it propagates through a linearly birefringent material. The trajectory passes through the horizontally polarized point on the sphere and then back to the vertically polarized point, but is elliptically polarized at points in between. In contrast, FIG. 3B shows the trajectory of the same light field after propagating through a dispersive element including a chiral material, whose trajectory stays on the Poincare equator and is always linearly polarized. As a consequence, any color transmitted by the chiral material can be completely extinguished using a linear polarizer.

The polarization rotation angle (θᵣₒₜ) after transmission through a chiral medium is proportional to the thickness (L) and circular birefringence (Δn_{c}) and inversely proportional to the optical wavelength (λ) according to: θᵣₒₜ=πΔn_{c} (λ)L/λ. Limonene is used as the chiral medium in some embodiments, as it has a relatively large circular birefringence, Δn_{c}=3.1×10⁻⁶ at 600 nm. The spectral filter functions follow Malus' law according to:

T(θᵢ,λ)=cos²(θₒᵤₜ−(θᵢₙ+θᵣₒₜ)).

where θᵢₙ is the rotation angle of the input polarizer and θₒᵤₜ is the rotation angle of the output polarizer. Rotating θᵢₙ shifts the phase of the spectral filter functions enabling fine tuning of the peak and the null wavelengths.

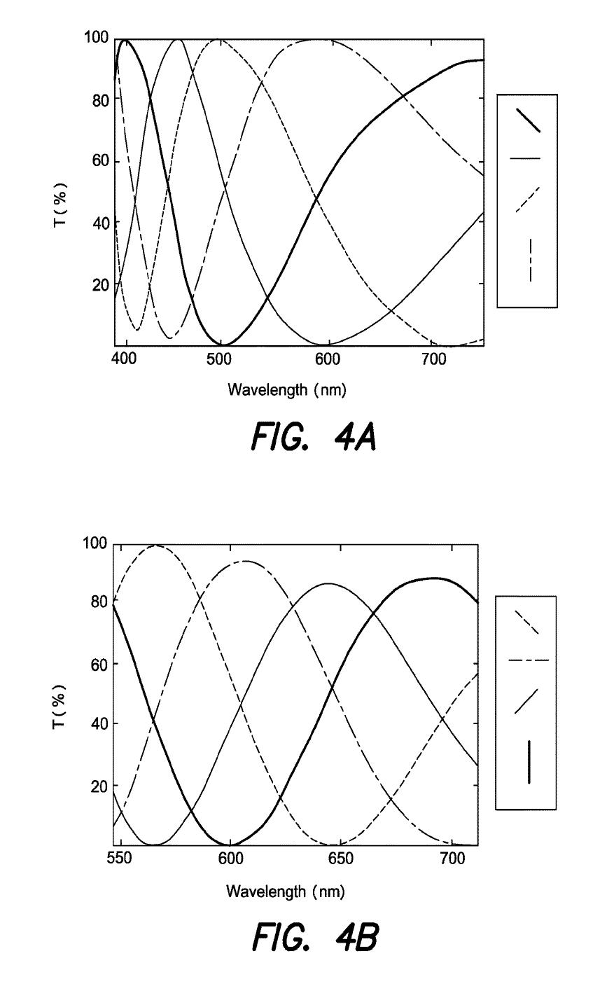

In some embodiments where the dispersive element comprises a tube of chiral liquid, the polarization color filter may be tunable based on the length of the dispersive element used. FIG. 4 shows transmission spectra, normalized for polarized illumination of the chiral disperser through uniform polarizers at four output polarization angles. FIG. 4A shows a transmission spectrum for a color filter array including a 10 cm chiral dispersive element, and FIG. 4B shows a transmission spectrum for a color filter array implemented using a 30 cm chiral dispersive element. The 10 cm chiral dispersive element (FIG. 4A) produces a CFA that spans the visible and near infrared regions, whereas the 30 cm chiral dispersive element (FIG. 4B) produces a CFA that has higher spectral resolution, but operates on a smaller spectral dynamic range. Because of the cyclic nature of Malus' law, the 30 cm chiral dispersive element preferably is used in combination with a bandpass filter that isolates each spectral range, similar to an order soring filter in grating spectroscopy.

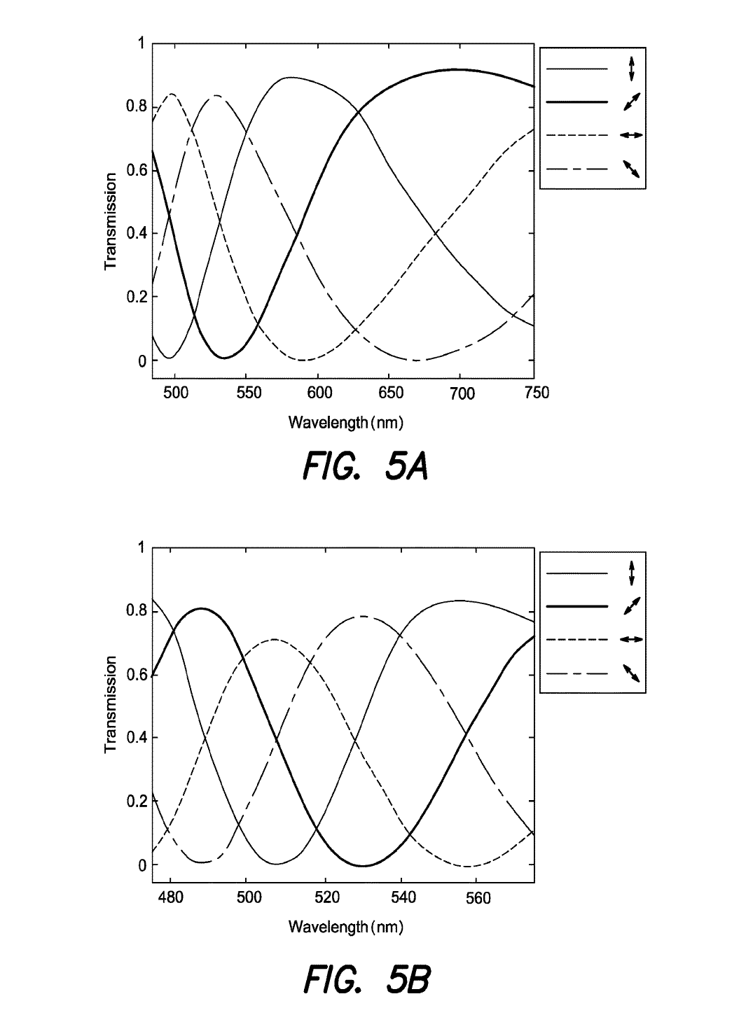

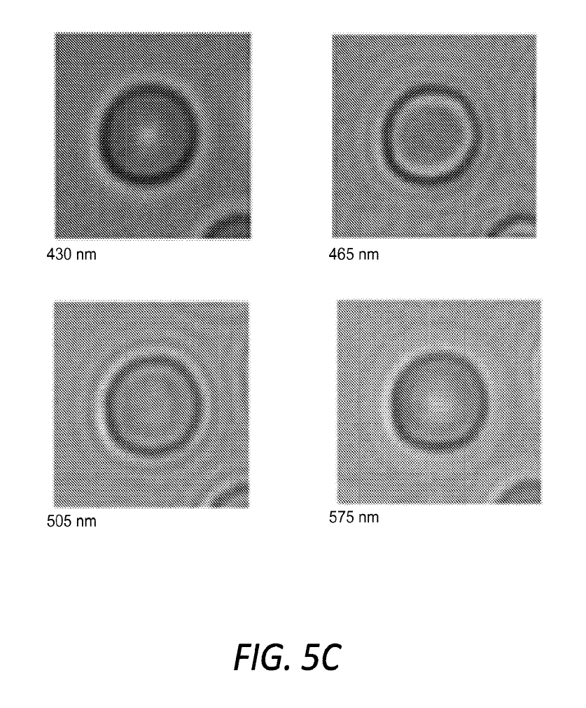

FIGS. 5A and 5B show the transmission spectra through dispersive elements that are six and twelve inches long and use Limonene as the optically active material. The twelve inch dispersive element has higher spectral resolution and shorter spectral dynamic range, as can be seen by the period of oscillation of the transmission curves. FIG. 5C illustrates a multispectral image of hemoglobin in a red blood cell recorded using an imaging apparatus constructed in accordance with some embodiments. It is evident from FIG. 5C that multiple images corresponding to different spectra can be recorded in a single exposure using techniques and apparatus described herein.

Some embodiments include dispersive elements other than a straight tube filled with an optically-active liquid. For example, in some applications, a more compact dispersive element may be desired. For such applications, the dispersive element may comprise a flexible curving tube operating as a waveguide, which may be coiled to reduce the dimension of the dispersive element. Alternatively, the dispersive element may comprise an optical isolator, which rotates the polarization of incident light based on the Faraday effect as a result of an magnetic field being induced in the optical isolator through the application of a current to the dispersive element. Such a dispersive element, which is tunable merely by changing the amount of current applied to the element, may have an added advantage of simplified tuning without having to replace the dispersive element. Other types of optically dispersive elements, including, but not limited to, dispersive elements that operate using birefringence properties of materials (e.g., crystals, mechanically-stressed plastics, etc.), may alternatively be used, and embodiments are not limited in this respect.

In some embodiments, dispersive element 140 comprises a liquid crystal element, enabling the dimension of the dispersive element to be reduced substantially compared to a dispersive element comprising a straight tube filed with an optically-active liquid. For example, rather than using a 10 cm chiral-liquid based dispersive element described above, some embodiments use a liquid crystal element as the dispersive element, which enables the entire imaging apparatus to be integrated into a package smaller than 1 cm³. In some embodiments, the entire imaging apparatus may be integrated into a package having a no dimensions greater than 1 cm. Reducing the size of the imaging apparatus permits imaging applications that are not possible with larger multispectral imagers including, but not limited to, incorporation of the imaging apparatus in mobile electronics (e.g., cell phones, smart phones, laptop computers), biomedical instruments (e.g., endoscopes), sensor-based electronics (e.g., automobile safety systems), or any other suitable application that requires a small imaging apparatus.

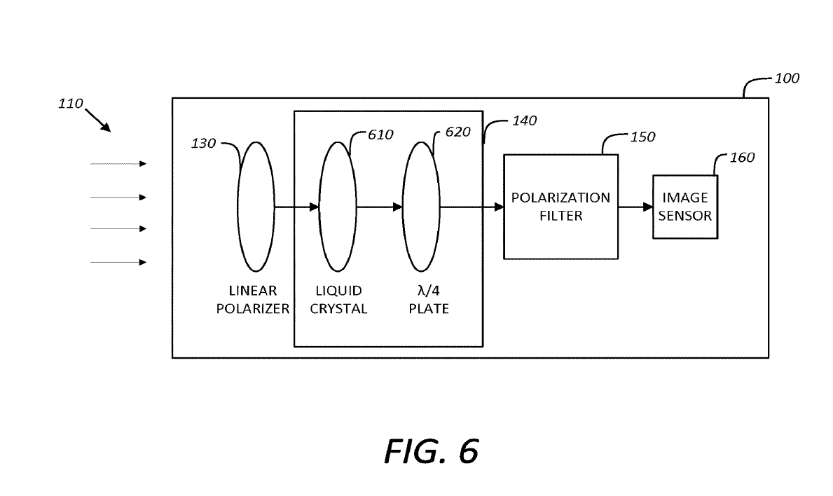

FIG. 6 shows a schematic of an imaging apparatus 100 including a liquid crystal dispersive element in accordance with some embodiments. Incident radiation 110 is optionally focused by a lens (not shown), and is linearly polarized by linear polarizer 130. The linearly-polarized radiation is transmitted to dispersive element 140, where color in the radiation is encoded based on polarization, as discussed above. Dispersive element 140 shown in FIG. 5 includes liquid crystal film 610 and quarter waveplate 620. Liquid crystal film 610 may comprise, for example, a nematic liquid crystal film. Quarter waveplate 620 may be made of any suitable material. For example, quarter waveplate 620 may comprise a crystalline and/or polymer substrate, and may be implemented as a thin-film broadband quarter waveplate. In some embodiments, quarter waveplate may be optimized to provide a broad bandwidth while minimizing the required thickness of the waveplate.

In some embodiments, linear polarizer 130, liquid crystal film 610, and quarter waveplate 620 may be combined as an integrated dispersive element having a thickness sufficiently small to enable imaging applications similar to those for a camera with a conventional thin-film or dye-based CFA. For example, in some embodiments, the integrated dispersive element may have a thickness of less than or equal to 3 mm. An additional advantage of embodiments that include a liquid crystal dispersive element is that the optical rotation of the liquid crystal element can be electrically tuned in real time enabling the collection of different set of color images without an exchange of physical components.

Similar to the imaging apparatus 100 shown in FIG. 1, imaging apparatus 100 shown in FIG. 6 includes polarization filter 150, which receives the output of dispersive element 140 and characterizes the radiation based on its polarization characteristics. Imaging apparatus 100 shown in FIG. 6 also includes an image sensor 160, which receives the output of polarization filter 150. The information recorded by image sensor 160 is used to produce color images.

The inventors have recognized and appreciated that a limitation of some conventional thin-film or dye-based CFAs is that once constructed and integrated with an imaging apparatus, they have a fixed spectral response, which is not tunable. For example, the Bayer filter can capture only three colors, and even color filter arrays that include more than three colors cannot be tuned for specific applications, light conditions, or sample irregularities. Some embodiments are directed to imaging apparatuses that can switch their CFA filter response. As discussed above, in some embodiments, this may be accomplished by interchanging dispersive elements of different lengths. In embodiments that include a dispersive element based on a liquid crystal filter, the properties of the filter itself may be tunable based on the birefringent properties of the liquid crystal and a voltage applied to the liquid crystal.

Some conventional imaging systems have used liquid crystal films as spectral filters, but such systems are capable of only capturing one color at a time. These systems also use the polarization of light transmitted through the liquid crystal film for color filtering, but employ only a single state polarizer. Some embodiments are directed to an imager that uses a multiple state polarizer, which makes possible multiple color acquisition in a single exposure. To obtain a high filter extinction ratio, the output polarization state transmitted by the liquid crystal should be linear. In some embodiments, this functionality is implemented by placing the liquid crystal film in series with a quarter waveplate. Accordingly, the combination of a birefringent material, a nematic liquid crystal film, and a quarter waveplate can be used as a dispersive element in place of optically-active material, as discussed above.

A pixilated polarizer for use in accordance with embodiments may be implemented in any suitable way. In the example illustrated in FIG. 2, the pixilated polarizer comprises unit elements of four micropolarization filters, and the unit elements are repeated to cover the entire image sensor array. The micropolarization filters in each unit element are designed to selectively pass radiation having polarization angles of 0°, 45°, 90°, and 135°. It should be appreciated however, that any number of micropolarization filters (including only two filters) that pass radiation having any particular polarization angle may alternatively be used. Additionally, any unit element size and arrangement may alternatively be used depending on the requirements for any particular implementation.

In the portion of the imaging device shown in FIG. 2, four different images can be captured in a single exposure. Each image passes through a polarizer of a different rotation angle, which produces a different color filter. While the pixels may not be dynamically tunable, the filter parameters of the imaging device may be controlled by placing different optical dispersive elements into the optical path, as described above. As discussed above, the spectral response of the color filter array may be dynamically tunable by, for example, applying different voltages to a liquid crystal, when the liquid crystal is used as a dispersive element.

In some embodiments, a pixelated polarizer in accordance with some embodiments may be bonded to an image sensor using any suitable bonding techniques and bonding agent(s). In some embodiments, one or more components of the pixelated polarizer may be fabricated together as a monolithic structure according to known techniques for fabricating optical components.

The inventors have recognized and appreciated that the ability to use single-shot multispectral imaging is important for capturing information about dynamic events that other spectroscopic imaging systems would miss. This is particularly important in biomedical imaging of live cells and living tissue. In many cases, it is not just the spectrum of an object that is important, but how this spectrum changes with time. Some imaging system embodiments described herein may be used to observe the absorption dynamics of hemoglobin in two different contexts, which will both add to the medical understanding of the vasculature system and cancer metastasis any may be used in a wide range of health diagnostics.

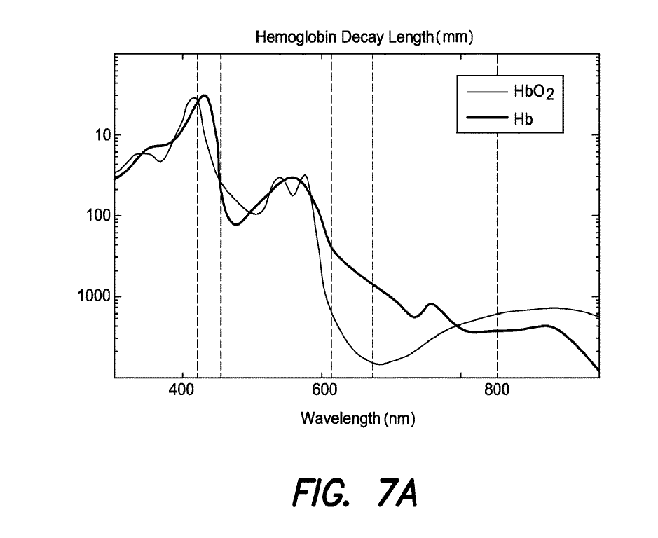

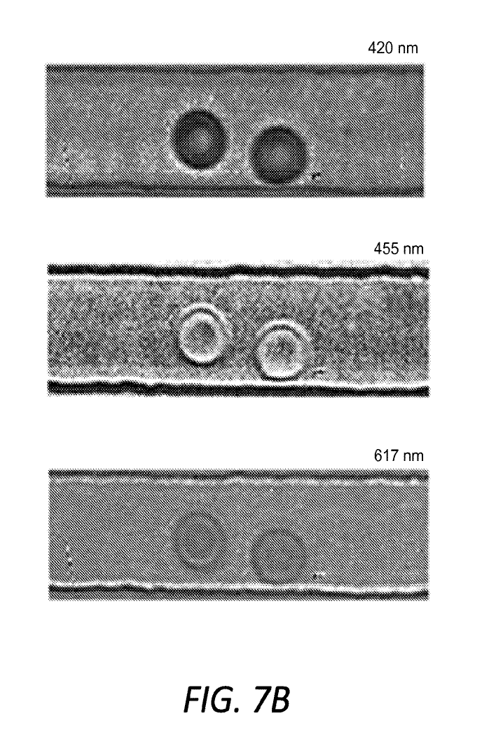

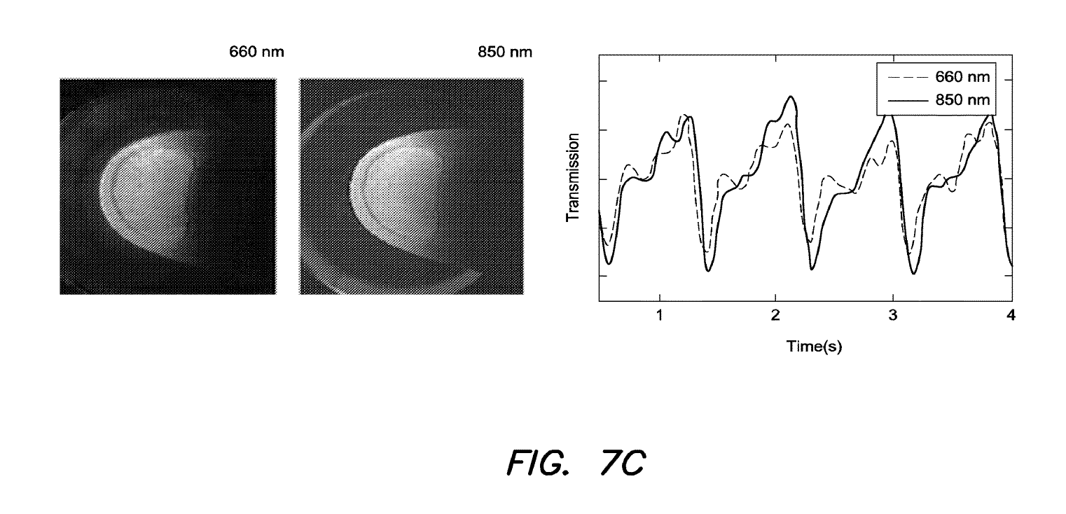

In a first implementation of a PTCF system described herein, the imaging system may be used to study the dynamics of oxygen release by individual red blood cells. A better understanding of these complex dynamics will help inform treatments for sickle cell disease as well as the causes of tumor hypoxia. In order to resolve oxygenation of single cells, the wavelength of interest for the PTCF system should to be tuned to the absorption peak of hemoglobin which is at 420 nm. By tuning the optical dispersive element, both total hemoglobin and its oxygen saturation can be evaluated at the cellular or tissue level by processing multispectral transmittance or reflectance values using the same optical system. Depending on the optical pathlength in tissue, different sets of wavelengths are optimal. The absorption spectrum and the corresponding decay length of light propagating through blood with a physiological hemoglobin concentration of 2.3 mM, is shown in FIG. 7A.

To characterize hemoglobin on a cellular level, optical wavelengths should be chosen that have a large relative absorption. An imaging apparatus constructed in accordance with some embodiments was used in combination with a standard transmission microscope to capture images of individual red blood cells traveling through a microfluidic channel using three LEDs having wavelengths of 420, 455, and 617 nm, as shown in FIG. 7B. Cells were flowing at a velocity of 100 μm/s and consequently required single-shot acquisition to avoid a difficult image registration process that would have been required for images captured using conventional scanning-based spectroscopic techniques. Both 420 and 455 nm LEDs were spectrally located at isobestic points, which reduced sensitivity to the oxygen saturation levels. Hemoglobin has a pronounced absorption peak in the deep blue, called the Soret band, which produces a decay length in the whole blood of 5 μm, giving strong contrast to single cell measurements. Red light has minimal hemoglobin absorption on a single cell level and can be used to characterize cell scattering instead of absorption.

In a second implementation, some embodiments of the imaging system described herein may be used as an imaging pulse oximeter, which measures the oxygen saturation of tissue. An imaging pulse oximeter enables non-contact measurement of the saturation over a large region of the body, which could be valuable for observing localized regions of decreased oxygenation or ischemia. Pulse oximetry requires simultaneous measurement of at least two different wavelengths, commonly red and infrared, and also requires temporal resolution of approximately video rate. Because of the rapid temporal resolution needed for pulse oximetry, an imaging system as discussed herein may provide significant advantages over conventional scanning multispectral imaging systems, which sequentially capture images corresponding to the multiple wavelengths of interest.

An imaging system constructed in accordance with some embodiments was used to capture images of a thumb, as shown in FIG. 7C. The images in FIG. 7C were collected with an imaging apparatus tuned to discriminate two LEDs with wavelengths of 660 and 850 nm. By integrating the signal collected through the nail, the pulse can be retrieved at both wavelengths, where the greater signal contrast for the 850 nm light indicates oxygen saturation of the arterial blood. Imaging could enable the spatial resolution of decreased blood flow or oxygen saturation levels.

A multispectral imaging system incorporating aspects of the technology described herein may be configured to have any suitable combination of spectral resolution and dynamic range. For example, a first implementation may have high spectral resolution, approximately 10 nm, and operate in the blue and near UV spectral region. A second implementation may span the visible spectrum and a portion of the near-infrared spectrum. These exemplary designs are optimized for single cell and tissue hemoglobin spectroscopy, respectively, however other configurations designed for other applications are also possible. Because the PTCF has a sinusoidal response in frequency, they require careful selection of the source and may require an additional bandpass filter that sets the entire spectral dynamic range of the measurement.

As discussed above, some implementations may be directed to medical diagnostic applications or biological research applications. However, other implementations and applications are possible including, but not limited to, infrared imaging, security and/or military surveillance, environmental inspection, machine vision, and manufacturing inspection systems, among others.

In one application, the imaging system discussed herein may be used for multicolor fluorescence. For example, by tuning the optical dispersive element for a particular application, the color response of the imaging system may be tuned to the fluorescence response in a biological sample. Several single-shot exposure techniques may be developed to detect the fluorescence at multiple times during a biological experiment to create fluorescence-sensitive color videos of biological activity on a fine time scale. Another application in biological research is to image biological objects (e.g., cells, fluids) while in motion. Such measurements are difficult with conventional scanning multispectral imaging techniques, which do not provide the desired temporal resolution.

Yet another application is to use the imaging system described herein for ratiometric fluorescence imaging, which is based on a ratio between two fluorescence intensities. In such an application, the imaging system may simultaneously measure both fluorescence intensities resulting in more dynamic measurements than can be achieved with conventional imaging approaches. For example, in one implementation, the imaging system described herein may be used to determine where the body is producing oxygen or calcium.

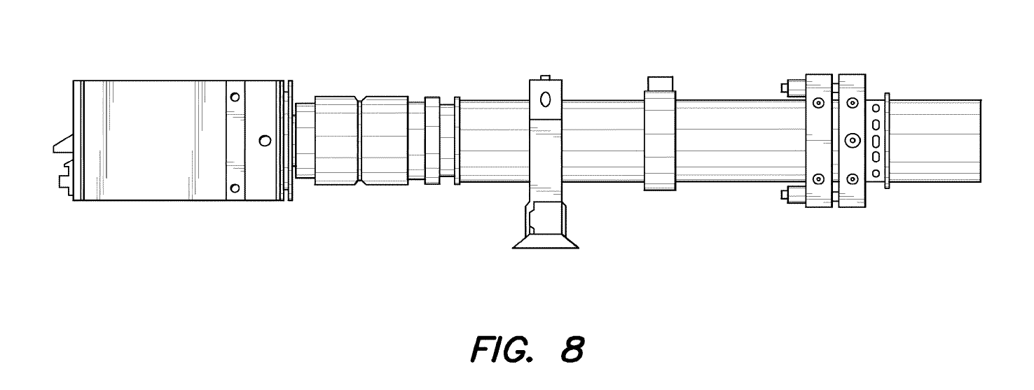

FIG. 8 illustrates an imaging system constructed in accordance with some embodiments that use a dispersive element comprising a straight tube filled with an optically-active liquid, as discussed above. The system includes a sensor size of 648×488 pixels with an equivalent number of micropolarizers alighted and bonded to the surface. The system also includes a 25 mm focal length lens, a 10 cm chiral dispersive element, and a broadband input polarizer. Similar to cameras using Bayer filters, color correction was used to compensate for overlap in the filter spectra. A simplified color mixing matrix can be analytically derived from Malus' law as:

$$[ {M}_{i , j} ] = [ {( cos ( \frac{π}{d} ( j - i ) ) )}^{2} ] ,$$

where d is the matrix dimension. This model assumes that the transmission function are sinusoidal, which ignore the nonlinearity of θ_{ref}(λ) and dispersion in the chiral medium. For a four state pixelated polarizer, d is equal to four and the mixing matrix becomes:

$$[ M ] = [ \begin{matrix}1 & 0.5 & 0 & 0.5 \\ 0.5 & 1 & 0.5 & 0 \\ 0 & 0.5 & 1 & 0.5 \\ 0.5 & 0 & 0.5 & 1\end{matrix} ] .$$

This matrix has a rank of three, implying that four colors cannot be independently retrieved from a single exposure. In addition, all matrices derived from the equation above with d≧3 also have a rank of three, implying that a pixelated polarizer with more than three state may not improve the number of resolvable spectral channels, provided that the assumptions in the above equation are reasonable.

Empirically it was found that a four color demixing matrix was ill-conditioned, so in this illustrative embodiment, imaging was constrained to three colors. For artificial illumination, this was done by illuminating the object with three colors corresponding to the peaks of the transmission spectrum. This can also be done in natural light using a hot or cold filter to remove light at one of the transmission peaks, similar to a conventional RGB camera that use a hot filter to eliminate infrared light. The demixing matrix was experimentally evaluated using a single color illumination to quantify spectral mixing at the desired wavelengths. The demixing matrix was then iteratively solved for by maximizing the signal in the desired color channel and minimizing the signal in the undesired color channels. Under quasi-monochromatic illumination from LEDs, an extinction ratio of approximately 30:1 was obtained in the desired versus undesired color channels.

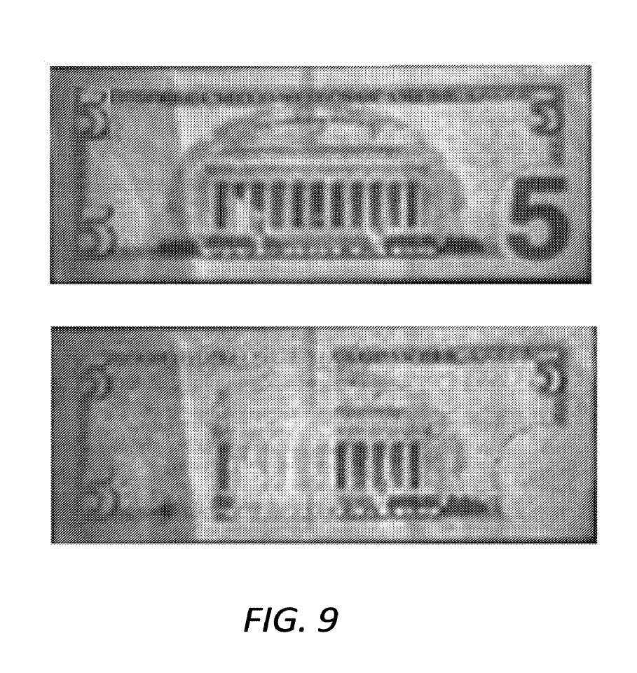

The imaging apparatus shown in FIG. 8 was used to perform multispectral imaging using multiple spectral configurations. A Munsell ColorChecker chart was illuminated with red (617 nm), green (525 nm), and blue (455 nm) LEDs. Each of the colors was faithfully reproduced by the imaging apparatus. In additional to red, green, and blue pixels, the imaging apparatus capturee light with a wavelength centered in the near-infrared range at 800 nm. FIG. 9 shows an image of a five dollar bill in the red and green (top) and infrared (bottom) spectrum that has been illuminated with three LEDs emitting at 617, 525, and 850 nm. American five dollar bills are printed with a special ink that is transparent in the infrared range, as can be seen in the bottom image where the large number five has disappeared.

The imaging apparatus was also tested to capture moving objects (e.g., a moving car and a moving train) in sunlight. The red channel contained both red and infrared light, so vegetation in the images has a distinctly red hue due to its large infrared reflectivity. In both cases, the moving car and train require single shot acquisition, which is not possible with scanning technologies (e.g., filter wheels) or liquid crystal tunable filters, which can only acquire a single color for each exposure.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments of the technology can be implemented in any of numerous ways. For example, the embodiments may be implemented using hardware, software or a combination thereof. When any aspect of an embodiment is implemented at least in part in software, the software code can be executed on any suitable processor or collection of processors, whether provided in a single computer or distributed among multiple computers.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

Also, the technology described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

What is claimed is:

1. An imaging apparatus, comprising:
an image sensor array including a plurality of image sensor elements;
a dispersive element configured to rotate incident linearly polarized radiation by a rotation angle to produce rotated linearly polarized radiation having at least two polarization angles, wherein the rotation angle is determined based, at least in part, on a wavelength of the incident linearly polarized radiation; and
a pixelated polarizing filter configured to receive the rotated linearly polarized radiation from the dispersive element and selectively pass the rotated linearly polarized radiation to the image sensor array, wherein the rotated linearly polarized radiation is selectively passed based on the polarization angle of the rotated linearly polarized radiation.

2. The imaging apparatus of claim 1, wherein the dispersive element comprises an optically-active material.

3. The imaging apparatus of claim 1 or any preceding claim, wherein the dispersive element is configured to rotate the incident linearly polarized radiation by a rotation angle inversely proportional to the wavelength of the incident linearly polarized radiation.

4. The imaging apparatus of claim 1 or any preceding claim, wherein the pixelated polarizing filter includes a plurality of unit elements, wherein each of the unit elements includes at least two polarization filters configured to pass incident radiation having different polarization angles.

5. The imaging apparatus of claim 1 or any preceding claim, wherein the imaging apparatus is a pulse oximeter.

6. The imaging apparatus of claim 1 or any preceding claim, wherein the dispersive element comprises a liquid crystal element and a quarter waveplate.

7. The imaging apparatus of claim 6, wherein the liquid crystal element comprises a thin-film liquid crystal element configured to provide different optical rotations of incident radiation based, at least in part, on a voltage applied to the liquid crystal element.

8. The imaging apparatus of claim 1 or any preceding claim, wherein the imaging apparatus is configured to provide different spectral responses based, at least in part, on an electrical signal applied to the imaging apparatus.

9. The imaging apparatus of claim 1 or any preceding claim, wherein the imaging apparatus is configured to be integrated in a package, wherein no dimension of the package exceeds 1 cm.

10. The imaging apparatus of claim 1 or any preceding claim, further comprising:
a linear polarizer configured to produce the incident linearly-polarized radiation provided to the dispersive element.

11. A method of generating a plurality of color-filtered images in a single exposure, the method comprising:
rotating incident linearly polarized light by a rotation angle based, at least in part, on a wavelength of the incident linearly polarized light to produce rotated linearly polarized light;
filtering, by a pixelated polarization filter, the rotated linearly polarized light based on its rotation angle, wherein the pixelated polarization filter includes at least one first filter element that selectively passes rotated linearly polarized light having a first angle and at least second filter element that selectively passes rotated linearly polarized light having a second angle; and
generating a first image and a second image of the plurality of images based on light passing through the at least one first filter element, and the at least one second element, respectively.

12. The method of claim 11, wherein rotating incident polarized light comprises rotating incident polarized light using an optically-active material.

13. The method of claim 11 or 12, wherein rotating incident polarized light comprises rotating incident polarized light using a liquid crystal element and a quarter waveplate.

14. The method of claim 13, further comprising:
applying a voltage to the liquid crystal element to produce rotated linearly polarized light having particular spectral characteristics.

15. A tunable multispectral imaging system for simultaneously measuring radiation at multiple wavelengths, the multispectral imaging system comprising:
a tunable optical dispersive element configured to encode color information by rotating incident light at particular rotation angles based on a wavelength of the incident light;
a polarization filter including a plurality of filter elements, wherein at least two of the filter elements are configured to selectively pass the rotated incident light having different polarization angles; and
an image sensor array configured to sense the light passed by the polarization filter and to generate multiple color images based on the sensed light.

16. The tunable multispectral imaging system of claim 15, wherein the tunable optical dispersive element comprises an electrically-tunable optical dispersive element.

17. The tunable multispectral imaging system of claim 15, wherein the tunable optical dispersive element comprises an interchangeable optical dispersive element.

18. The tunable multispectral imaging system of claim 15, wherein the tunable optical dispersive element comprises an optically-active material.

19. The tunable multispectral imaging system of claim 15, wherein the tunable optical dispersive element comprises a liquid crystal element and a quarter waveplate.

20. The tunable multispectral imaging system of claim 15, further comprising:
a linear polarizer configured to produce linearly polarized light provided as the incident light to the tunable optical dispersive element.
